(19) United States
(12) Patent Application Publication
(10) Pub. No.: US 2024/0259483 A1
(43) Pub. Date: Aug. 1, 2024

(54) METHOD AND APPARATUS FOR HANDLING PROTOCOL STACK IN WIRELESS COMMUNICATION SYSTEM

(71) Applicant: Samsung Electronics Co., Ltd., Suwon-si (KR)

(72) Inventors: Aneesh DESHMUKH, Bangalore (IN); Nayan OSTWAL, Bangalore (IN); Neha SHARMA, Bangalore (IN); Mahantesh KOTHIWALE, Bangalore (IN); Anshuman NIGAM, Bangalore (IN); Mayank SONU, Bangalore (IN); M Sasank SAI, Bangalore (IN); Jiyoung CHA, Suwon-si (KR); Dongmyoung KIM, Boram-ro (KR)

(21) Appl. No.: 18/428,361

(22) Filed: Jan. 31, 2024

(30) Foreign Application Priority Data
Jan. 31, 2023 (IN) 202341006292
Sep. 22, 2023 (IN) 2023 41006292

(51) Int. Cl. H04L 69/324; H04W 80/04

(52) U.S. Cl. CPC H04L 69/324; H04W 80/04

(57) ABSTRACT

A method for processing at least one Internet Protocol (IP) packet performed by a converged layer 2 (L2) in a wireless communication system is provided. The method includes receiving, by the converged L2, at least one internet protocol (IP) packet as a service data unit (SDU) from an IP layer, assigning, by the converged L2, a sequence number to the received at least one IP packet, adding, by the converged L2, at least one L2 header to the received at least one IP packet to process a protocol data unit (PDU), and transmitting, by the converged L2, the processed at least one PDU to at least one medium access control (MAC) lower layer.

### CROSS REFERENCE TO RELATED APPLICATION(S)

This application is based on and claims priority under 35 U.S.C. § 119(a) of Indian Provisional patent application number 202341006292, filed on Jan. 31, 2023, in the Indian Intellectual Property Office, and of an Indian Complete patent application number 202341006292, filed on Sep. 22, 2023, in the Indian Intellectual Property Office, the disclosure of each of which is incorporated by reference herein in its entirety.

### BACKGROUND

### 1. Field

The disclosure relates to wireless communication networks. More particularly, the disclosure relates to systems and methods for optimizing Layer 2 processing and mechanism in beyond fifth generation (5G)/sixth generation (6G) data plane.

### 2. Description of Related Art

Considering the development of wireless communication from generation to generation, the technologies have been developed mainly for services targeting humans, such as voice calls, multimedia services, and data services. Following the commercialization of 5th-generation (5G) communication systems, it is expected that the number of connected devices will exponentially grow. Increasingly, these will be connected to communication networks. Examples of connected things may include vehicles, robots, drones, home appliances, displays, smart sensors connected to various infrastructures, construction machines, and factory equipment. Mobile devices are expected to evolve in various form-factors, such as augmented reality glasses, virtual reality headsets, and hologram devices. In order to provide various services by connecting hundreds of billions of devices and things in the 6th-generation (6G) era, there have been ongoing efforts to develop improved 6G communication systems. For these reasons, 6G communication systems are referred to as beyond-5G systems.

6G communication systems, which are expected to be commercialized around 2030, will have a peak data rate of tera (1,000 giga)-level bps and a radio latency less than 100 μsec, and thus will be 50 times as fast as 5G communication systems and have the 1/10 radio latency thereof.

In order to accomplish such a high data rate and an ultra-low latency, it has been considered to implement 6G communication systems in a terahertz (THz) band (for example, 95 gigahertz (GHz) to 3 THz bands). It is expected that, due to severer path loss and atmospheric absorption in the terahertz bands than those in millimeter wave (mmWave) bands introduced in 5G, technologies capable of securing the signal transmission distance (that is, coverage) will become more crucial. It is necessary to develop, as major technologies for securing the coverage, radio frequency (RF) elements, antennas, novel waveforms having a better coverage than orthogonal frequency division multiplexing (OFDM), beamforming and massive multiple input multiple output (MIMO), full dimensional MIMO (FD-MIMO), array antennas, and multiantenna transmission technologies such as large-scale antennas. In addition, there has been ongoing discussion on new technologies for improving the coverage of terahertz-band signals, such as metamaterial-based lenses and antennas, orbital angular momentum (OAM), and reconfigurable intelligent surface (RIS).

Moreover, in order to improve the spectral efficiency and the overall network performances, the following technologies have been developed for 6G communication systems a full-duplex technology for enabling an uplink transmission and a downlink transmission to simultaneously use the same frequency resource at the same time, a network technology for utilizing satellites, high-altitude platform stations (HAPS), and the like in an integrated manner, an improved network structure for supporting mobile base stations and the like and enabling network operation optimization and automation and the like, a dynamic spectrum sharing technology via collision avoidance based on a prediction of spectrum usage, an use of artificial intelligence (AI) in wireless communication for improvement of overall network operation by utilizing AI from a designing phase for developing 6G and internalizing end-to-end AI support functions, and a next-generation distributed computing technology for overcoming the limit of user equipment (UE) computing ability through reachable super-high-performance communication and computing resources (such as mobile edge computing (MEC), clouds, and the like) over the network. In addition, through designing new protocols to be used in 6G communication systems, developing mechanisms for implementing a hardware-based security environment and safe use of data, and developing technologies for maintaining privacy, attempts to strengthen the connectivity between devices, optimize the network, promote softwarization of network entities, and increase the openness of wireless communications are continuing.

It is expected that research and development of 6G communication systems in hyper-connectivity, including person to machine (P2M) as well as machine to machine (M2M), will allow the next hyper-connected experience. Particularly, it is expected that services such as truly immersive extended reality (XR), high-fidelity mobile hologram, and digital replica could be provided through 6G communication systems. In addition, services such as remote surgery for security and reliability enhancement, industrial automation, and emergency response will be provided through the 6G communication system such that the technologies could be applied in various fields such as industry, medical care, automobiles, and home appliances.

In recent years, several broadband wireless technologies have been developed to meet the growing number of broadband subscribers by providing better applications and services. Second-generation wireless communication systems have been developed to provide voice services, while ensuring the mobility of users. A third-generation wireless communication system supports not only voice services, but also data services. In recent years, a fourth wireless communication system has been developed to provide high-speed data service. However, currently, the fourth generation (4G) or Long Term Evolution (LTE) wireless communication system suffers from a lack of resources to meet the growing demand for high-speed data services. This problem is solved by the deployment of a fifth-generation wireless communication system to meet the ever-growing demand for high-speed data services. Furthermore, the fifth-generation (5G) or New Radio (NR) wireless communication system provides ultra-reliability and supports low-latency applications.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide methods and systems for processing at least one Internet Protocol (IP) packet and transmitting the processed at least one Protocol Data Unit (PDU) to at least one Medium Access Control (MAC) lower layer.

Another aspect of the disclosure is to provide methods and systems for optimizing Layer 2 processing and mechanisms beyond the 5G/6G data plane.

Another aspect of the disclosure is to provide a protocol stack having simplified protocols for a high-speed packet processing network by merging the functionalities of all the Layer 2 modules, (especially pocket data convergence protocol (PDCP) and radio link controller (RLC)) into a single network function, which provides an opportunity to make the processing lighter.

Another aspect of the disclosure is to provide a single layer for performing fast transfer of data with a single windowing mechanism, a single protocol header, clear segregation between real-time and non-real-time processing, along with all other functionalities (such as, but not limited to, recovery mechanisms, retransmissions, duplicate detection, security, header compression, and decompression).

Another aspect of the disclosure is to provide methods and systems for assigning a sequence number to at least one IP packet received as a Service Data Unit (SDU) from an IP layer.

Another aspect of the disclosure is to provide methods and systems for adding at least one L2 Header to the received at least one IP packet and assigning a L2 Sub-Header to the plurality of IP packets on detecting that more than one IP packet is present in a cluster.

Additional aspects will be set forth in part in the description which follows and, in part, will be apparent from the description, or may be learned by practice of the presented embodiments.

In accordance with an aspect of the disclosure, a method performed by a converged layer 2 (L2) is provided. The method includes receiving, by the a converged layer 2, at least one Internet Protocol (IP) packet as a Service Data Unit (SDU) from an IP layer, assigning, by the converged L2, a sequence number to the received at least one IP packet, adding, by the converged L2, at least one L2 header to the received at least one IP packet to process a Protocol Data Unit (PDU), and transmitting, by the converged L2, the processed at least one PDU to at least one Medium Access Control (MAC) lower layer.

In accordance with another aspect of the disclosure, an electronic device having a converged layer 2 (L2) for processing at least one internet protocol (IP) packet is provided. The electronic device includes memory and one or more processors communicatively coupled to the memory, wherein the memory store one or more computer programs including computer-executable instructions that, when executed by the one or more processors, cause the electronic device to receive at least one IP packet as a Service Data Unit (SDU) from an IP layer, assign a sequence number to the received at least one IP packet, add at least one L2 Header to the received at least one IP packet to process a Protocol Data Unit (PDU), and transmit the processed at least one PDU to at least one Medium Access Control (MAC) lower layer.

In accordance with another aspect of the disclosure, one or more non-transitory computer-readable storage media storing one or more computer programs including computer-executable instructions that, when executed by one or more processors of an electronic device, cause the electronic device to perform operations are provided. The operations include receiving, by a converged layer 2 (L2), at least one internet protocol (IP) packet as a service data unit (SDU) from an IP layer, assigning, by the converged L2, a sequence number to the received at least one IP packet, adding, by the converged L2, at least one L2 header to the received at least one IP packet to process a protocol data unit (PDU), and transmitting, by the converged L2, the processed at least one PDU to at least one medium access control (MAC) lower layer.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 shows a history of legacy protocols, according to the related art;

FIG. 2 illustrates an example of a data plane in LTE (4G) for packet processing, according to the related art;

FIGS. 3A and 3B illustrates a sample header structure in LTE (4G) for the RLC layer, according to the related art;

FIG. 4 illustrates an example of the data plane in NR (5G) for packet processing, according to the related art;

FIGS. 5A and 5B illustrates a sample header structure in NR (5G) for the RLC layer, according to the related art;

FIG. 6 illustrates a comparison between packet handling at PDCP and RLC between LTE (4G) and NR (5G), according to the related art;

FIG. 7 illustrates layered processing across different layers on a typical modem processor stack, highlighting real-time and non-real time processing in NR (5G), according to the related art;

FIG. 8 depicts the procedures that take place in an existing protocol stack, according to the related art;

FIG. 9 illustrates a protocol stack view for a proposed single layer processing for a next-generation wireless communication system, according to an embodiment of the disclosure;

FIG. 10 illustrates an example of the proposed header structure required for a next-generation wireless communication system for fast-path processing, according to an embodiment of the disclosure;

FIG. 11 is an example block diagram depicting components of the proposed single layer processing for next next-generation wireless communication system, according to an embodiment of the disclosure;

FIG. 12 illustrates the operations to be performed once the IP packets have been received by the single L2 layer, according to an embodiment of the disclosure;

FIG. 13 illustrates the difference in handling between LTE, NR, and Converged L2, according to an embodiment of the disclosure;

FIG. 14 illustrates a scenario where there is concatenation at the L2 layer, according to an embodiment of the disclosure;

FIG. 15 illustrates another example of the packet structure based on the length indicator fields placed along with the data packets, according to an embodiment of the disclosure;

FIG. 16 illustrates another variant of the proposed header structure containing extra fields for a number of SDUs, according to an embodiment of the disclosure;

FIG. 17 illustrates a scenario where there is only a single data packet or no concatenation at Layer 2, according to an embodiment of the disclosure;

FIG. 18 shows the end-to-end protocol stack view as per the existing state-of-the-art Radio Access Network (RAN) deployment, according to an embodiment of the disclosure;

FIG. 19 shows one variant based on the proposed architecture impact due to Converged Layer2, according to an embodiment of the disclosure;

FIG. 20 shows another variant based on the proposed architecture for the single layer2 and converged UPF, according to an embodiment of the disclosure; and

FIG. 21 depicts a flowchart illustrating a method for processing at least one Internet Protocol (IP) packet, according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

For the purposes of interpreting this specification, the definitions (as defined herein) will apply and whenever appropriate the terms used in singular will also include the plural and vice versa. It is to be understood that the terminology used herein is for the purposes of describing particular embodiments only and is not intended to be limiting. The terms “comprising”, “having” and “including” are to be construed as open-ended terms unless otherwise noted.

The words/phrases “exemplary”, “example”, “illustration”, “in an instance”, “and the like”, “and so on”, “etc.”, “etcetera”, “e.g.,”, “i.e.,” are merely used herein to mean “serving as an example, instance, or illustration.” Any embodiment or implementation of the subject matter described herein using the words/phrases “exemplary”, “example”, “illustration”, “in an instance”, “and the like”, “and so on”, “etc.”, “etcetera”, “e.g.,”, “i.e.,” is not necessarily to be construed as preferred or advantageous over other embodiments.

Embodiments herein may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by a firmware. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

It should be noted that elements in the drawings are illustrated for the purposes of this description and ease of understanding and may not have necessarily been drawn to scale. For example, the flowcharts/sequence diagrams illustrate the method in terms of the steps required for understanding of aspects of the embodiments as disclosed herein. Furthermore, in terms of the construction of the device, one or more components of the device may have been represented in the drawings by conventional symbols, and the drawings may show only those specific details that are pertinent to understanding the embodiments so as not to obscure the drawings with details that will be readily apparent to those of ordinary skill in the art having the benefit of the description herein. Furthermore, in terms of the system, one or more components/modules which comprise the system may have been represented in the drawings by conventional symbols, and the drawings may show only those specific details that are pertinent to understanding the embodiments so as not to obscure the drawings with details that will be readily apparent to those of ordinary skill in the art having the benefit of the description herein.

The accompanying drawings are used to help easily understand various technical features and it should be understood that the embodiments presented herein are not limited by the accompanying drawings. As such, the disclosure should be construed to extend to any modifications, equivalents, and substitutes in addition to those which are particularly set out in the accompanying drawings and the corresponding description. Usage of words such as first, second, third etc., to describe components/elements/steps is for the purposes of this description and should not be construed as sequential ordering/placement/occurrence unless specified otherwise.

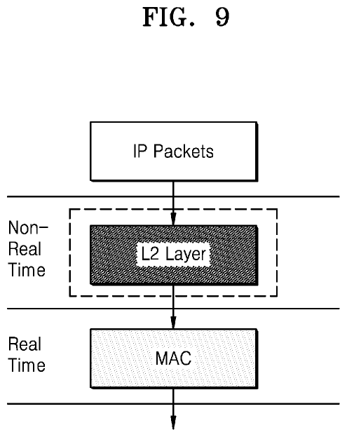

The embodiments herein achieve a protocol stack having simplified protocol for a high speed packet processing network by merging the functionalities of all the Layer 2 modules, especially Packet Data Convergence Protocol (PDCP) and Radio Link Control (RLC), into a single network function. Referring now to the drawings, and more particularly to FIGS. 9 through 21, where similar reference characters denote corresponding features consistently throughout the figures, there is at least one embodiment.

It should be appreciated that the blocks in each flowchart and combinations of the flowcharts may be performed by one or more computer programs which include instructions. The entirety of the one or more computer programs may be stored in a single memory or the one or more computer programs may be divided with different portions stored in different multiple memories.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an integrated circuit (IC), or the like.

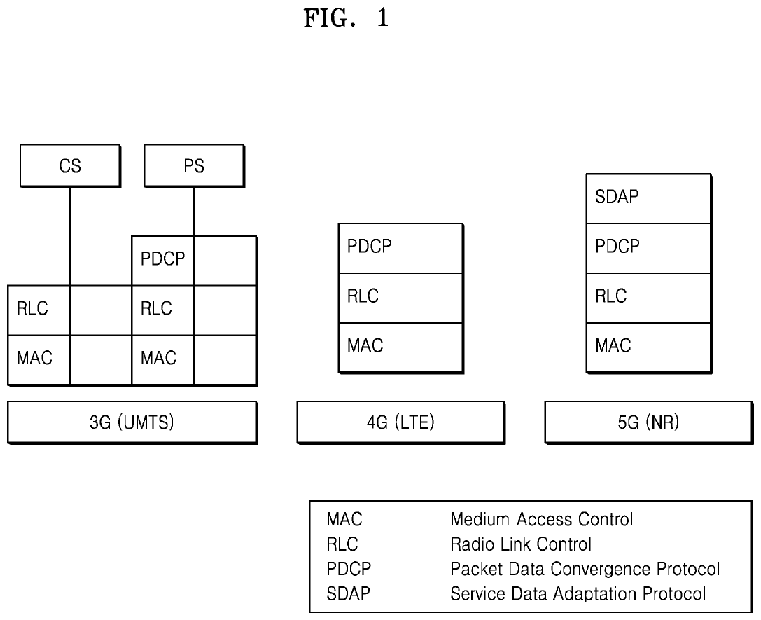

FIG. 1 depicts a history of legacy protocols according to the related art. In third-generation wireless communications, most of the data is handled as voice calls on Circuit Switched (CS) networks. A Packet Data Convergence Protocol (PDCP) is typically used only for Packet Switched (PS) networks. The important role of PDCP was header compression to reduce the IP packet header overhead using ROHC (Robust Header Compression). A Radio Link Control (RLC) layer supported ciphering.

In fourth-generation wireless communication, Evolved Packet Core (EPC) supports all data on PS networks to connect to the internet and PDCP supports ciphering and integrity protection. The PDCP is the anchor point for handover support, split bearer, dual connectivity, and reordering (which was introduced in the PDCP towards later releases).

In fifth-generation wireless communication, concatenation is removed at the RLC. Reordering and out-of-delivery were added as a base feature at PDCP. A Service Data Adaptation Protocol (SDAP) was added for Quality-of-Service (QOS) flow to Resource Block (RB) mapping.

With the advent of a further increase in data demand, high bandwidth, and processing capability, the next-generation wireless communication systems (i.e., beyond 5G and the sixth generation, or 6G) should be capable of meeting such ever-increasing requirements. For doing so, the communication protocol should be capable of processing high-speed data. In LTE, the protocols that exist for the user plane include PDCP, RLC, Medium Access Control (MAC), and the PHY protocol. The control plane stack additionally includes the Radio Resource Control (RRC) and Non-Access Stratum (NAS).

The RLC protocol layer exists in User Equipment (UE) and base station or eNodeB (eNB) and is part of the LTE air interface control and data planes. The main functionalities of the RLC for LTE (4G) are an error correction mechanism through Automatic Repeat Request (ARQ), an in-order delivery mechanism, a concatenation mechanism, a segmentation and reassembly mechanism, and a reordering mechanism.

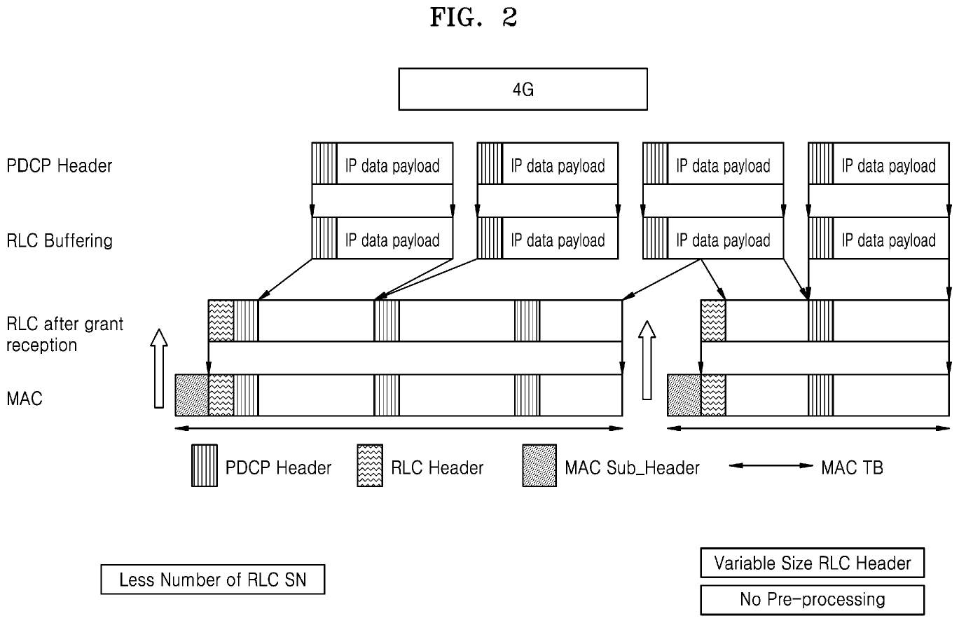

FIG. 2 illustrates an example of a data plane in LTE (4G) for packet processing according to the related art. When the RLC receives grants from a lower layer, a transmitter entity concatenates multiple PDCP Protocol Data Units (PDUs) or PDCP packets into an RLC PDU and assigns one RLC Sequence Number (SN) for an RLC PDU.

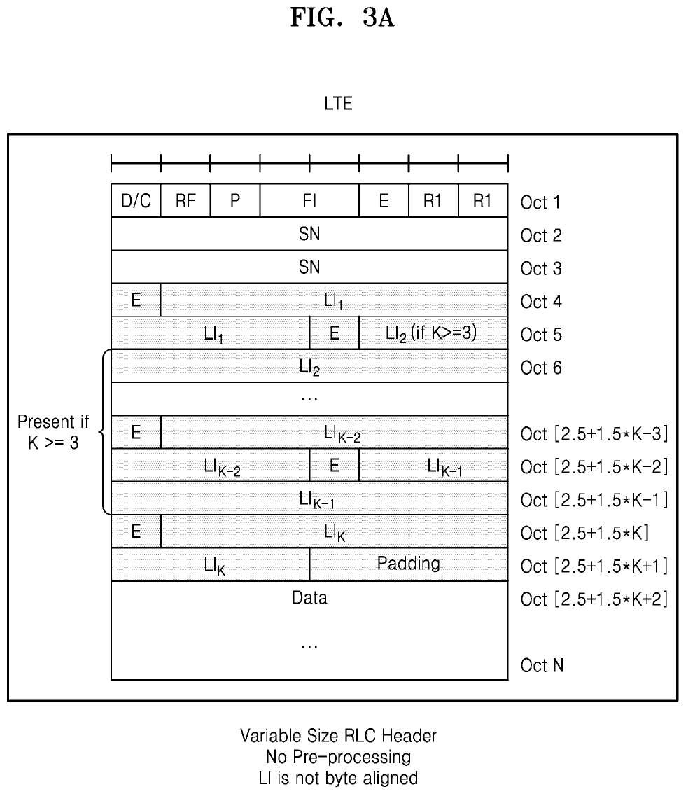

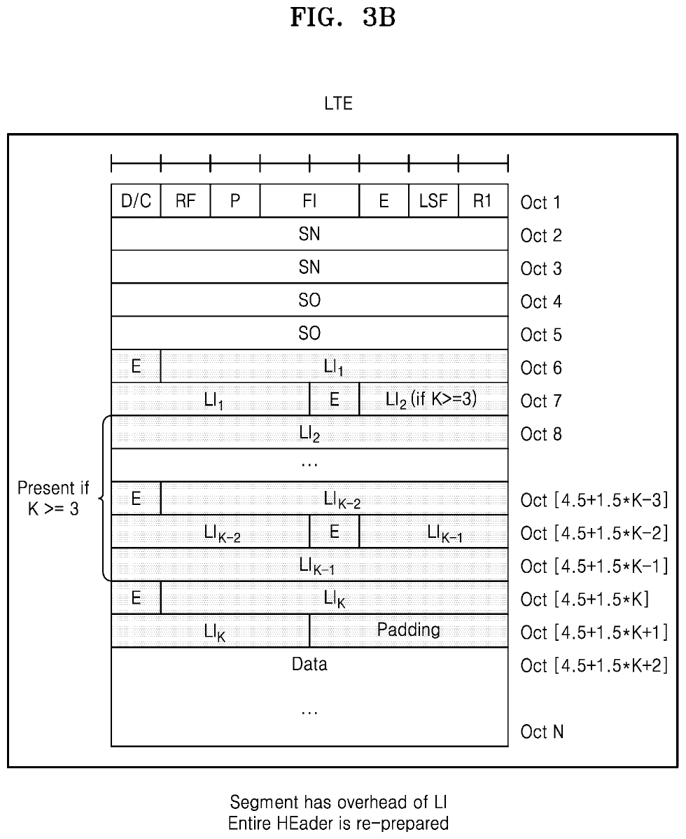

FIGS. 3A and 3B illustrates a sample header structure in LTE (4G) for the RLC layer according to the related art. The framing information (FI) field is updated to inform whether the first byte and the last byte of the RLC PDU correspond to the first byte and the last byte of an RLC SDU, respectively. The extension field (E) indicates whether a data field follows to indicate the end of the header or another extension follows or not, i.e., a set of E fields and L1 fields follows. The length indicator field (L1) indicates the length of the RLC SDU. In 4G, the E and L1 fields are not added, corresponding to the last concatenated PDCP PDU.

In LTE (4G), a single RLC SN is assigned when grants are available from the MAC, wherein the single RLC SN maps to multiple PDCP PDUs because of the concatenation of PDCP PDUs. Hence, the number of RLC SN required for a larger number of PDCP PDU packets is less, when the total size of the PDCP PDUs is smaller than or equal to the available grants. However, the RLC PDU is prepared only after receiving the grant, as the RLC cannot be pre-processed. If RLC PDU(s) are lost for the first time because of Block Error Rate (BLER), the status report generated only needs to report completely missed RLC SNs. Now, when a NACKED RLC SN is retransmitted in case there are fewer grants available, an Acknowledged Mode Data (AMD) PDU segment is sent, which is indicated using a Re-segmentation Flag (RF) in the header. However, the RLC header in LTE gives rise to various issues, for example, but not limited to:
1. Multiple header types lead to a variable size of the RLC header.
2. The number of PDCP PDUs to be packed cannot be known before a complete RLC header can be prepared after receiving grants. Hence, the L1 field in the RLC Header structure can be updated only after the grant.
3. In case of re-segmentation or retransmission of a NACKED RLC SN, the RLC Header needs to be updated to include the RF, LSF, and SO fields and re-fill the L1 information based on the number of PDCP PDUs getting concatenated during re-segmentation.
4. The length of the last PDCP PDU included in the concatenated RLC PDU has to be computed by subtracting RLC PDU L1 fields for other PDCP PDUs from the total MAC PDU length.

Thus, it can be concluded that the LTE (4G) RLC Header yields the aforementioned problems by having a variable-size RLC Header and no pre-processing of RLC.

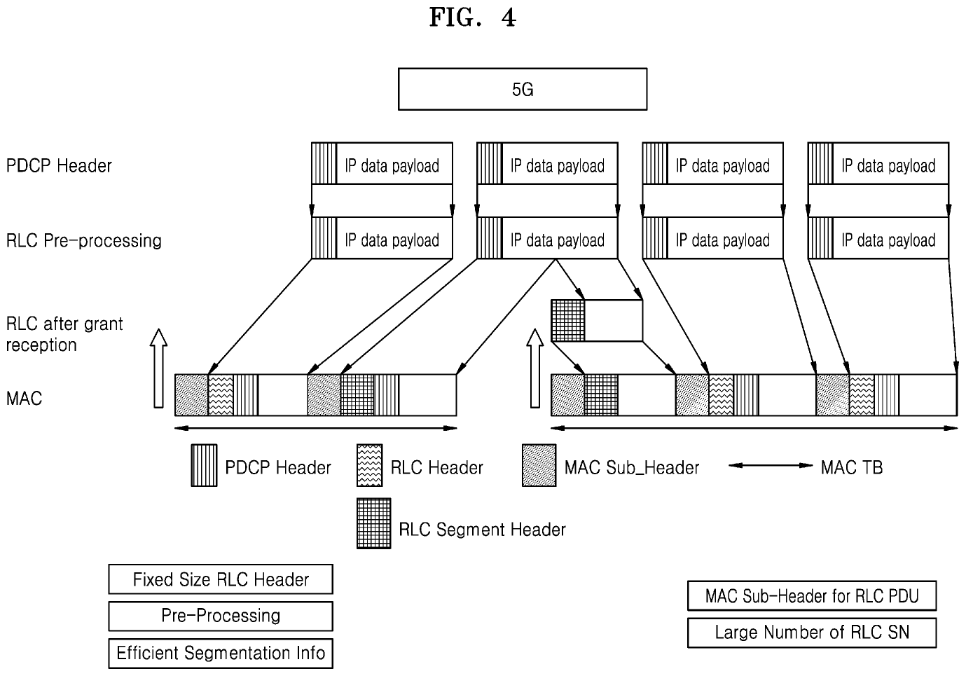

FIG. 4 illustrates an example of the data plane in NR (5G) for packet processing according to the related art.

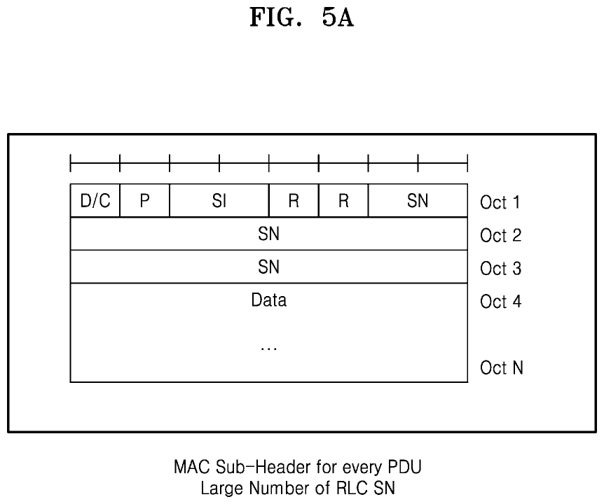

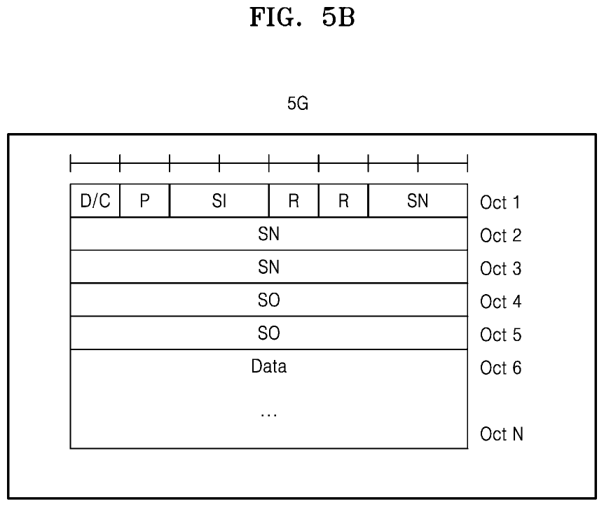

FIGS. 5A and 5B illustrates a basic RLC header(s) structure in NR (5G) for the RLC layer according to the related art. The main functionalities of the RLC for NR (5G) are the error correction mechanism through ARQ, the in-order delivery mechanism, the segmentation and reassembly mechanism, the reordering mechanism, and so on.

Thus, RLC for NR (5G) lacks the concatenation mechanism. The actual concatenation of packets happens in the MAC based on the grant received for that Transport Block (TB) transmission. Thus, without the concatenation mechanism, the single RLC SN maps to a single RLC SDU, i.e., one PDCP PDU, and hence, this is extremely advantageous in terms of pre-processing as it is independent of grant reception. The Segmentation Information Field (SI) indicates whether an RLC PDU contains a complete RLC SDU or the first, middle, and last segments of an RLC SDU. The segmentation offset field (SO) indicates the position of the RLC SDU segment in bytes within the original RLC SDU. In the case of segmentation, in the case of no grants, for the first segment, the SI field is enough to indicate the first segment, as SO=0 is redundant.

The advantages of the NR (5G) RLC Header can be listed as follows:
NR (5G) RLC header is of fixed size.
single RLC SN is assigned to a single PDCP PDU.
RLC Headers can be prepared even before the grant update operation.
Segmentation information can be easily filled in without many changes to the already pre-processed RLC complete PDU Header, as only the SI bit needs to be updated for the first segment to be transferred.
During segmentation or re-segmentation, RLC just has to prepare an RLC segment header with the SO field.

Thus, it can be concluded that the NR (5G) RLC Header provides at least a fixed-size RLC Header, an already pre-processed RLC, and efficient segment information.

On the other hand, the NR (5G) RLC Header yields various issues, such as:
In the NR (5G) RLC mechanism, a large number of RLC SNs are required for window maintenance, as a single RLC SN gets mapped to a single PDCP SN. Further, the processing cycle at the receiver end increases due to extra sequence numbers.
For every grant, the MAC has to prepare multiple MAC Sub-Headers, as the MAC Sub-Header captures the length of the RLC PDU information.
The length of each RLC PDU or RLC PDU segment is packed with the MAC Sub-Header.

Further, with the advent of further increases in data demand, high bandwidth, and processing capability, it is very much viable that a future modem communication protocol system, particularly in systems beyond 5G/6G, would have a huge requirement for high-speed data processing. Applications like high-definition video streaming, AR/VR, holography, and digital twin require dedicated processing and stringent Key Performance Index (KPI) requirements related to high throughput, low latency, and zero jitters all met simultaneously. In such highly interactive immersive applications, there is fundamentally no practical difference between a lost packet and a late packet because of the synchronization required for multiple streams of these applications. All the legacy protocol stack designs are focused on lossless data delivery, making them unsuitable for such highly interactive and immersive applications. Further, legacy protocols have layered processing, which involves significant processing at each layer. At adjacent layers like PDCP and RLC, there are duplicate functionalities like windowing, reordering, status reporting, etc., making a few functionalities redundant in some scenarios. Thus, it is required to simplify the processing by removing these redundancies across the complete protocol stack.

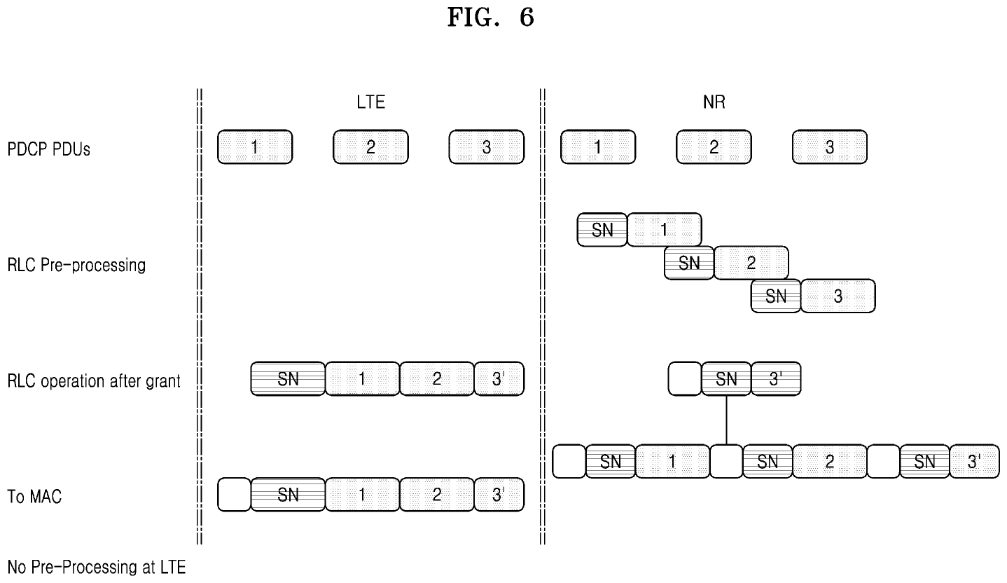

FIG. 6 illustrates a comparison between packet handling at PDCP and RLC between LTE (4G) and NR (5G) according to the related art.

Also, with an increased number of packets to be processed in a shortened Transmission Time Interval (TTI), there does not exist any solution to improve the data plane processing capability in various aspects to achieve extremely fast processing.

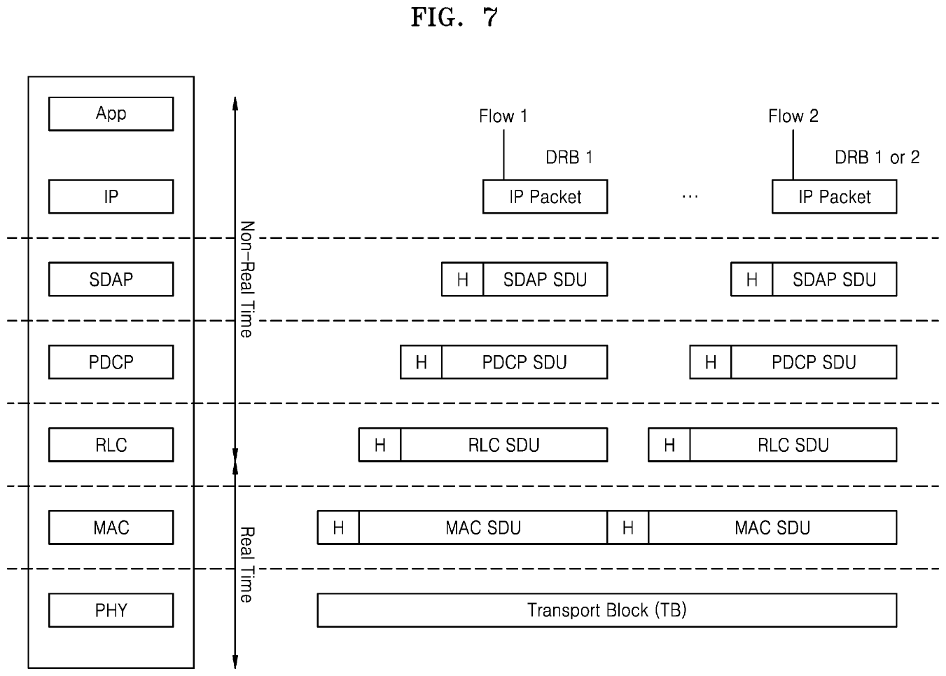

FIG. 7 illustrates layered processing across different layers on a typical modem processor stack, highlighting the real-time and non-real time processing in NR (5G), according to the related art. None of the above RLC functionalities are strictly real-time in nature. Except for segmentation handling at RLC and MAC grant handling, all processing can be considered as non-real time. In NR, packets from different applications can be mapped to the same DRB (Data Radio Bearer) or different DRBs. Each layer additionally receives a Service Data Unit (SDU) and then puts its own header to form the PDU. Each PDU comprises a layer header followed by SDU (for example, SDAP SDU, PDCP SDU, RLC SDU, and MAC SDU). The MAC layer concatenates multiple data packets and transfers these packets over the air in the form of transport blocks based on the grant (the amount of data that can be transmitted over the air). RLC performs the segmentation as described before, when grants are not sufficient. The protocol hierarchy involves significant processing and latency at each layer. Each layer involves significant processing in terms of header processing.

Recently, there have been many approaches to improving multi-core architecture designs. However, the current state-of-the-art techniques need to be simplified to reduce the overhead of processing functionalities for future generation protocols by providing a reliable communication mechanism for the application and transport layers as well. Further, the current functionality of recovery at the RLC layer is typically to overcome a portion of residual loss from the MAC layer. MAC also has a Hybrid Automatic Repeat request (HARQ) procedure to attempt recovery at subsequent retransmissions. The higher protocol layers in 4G or 5G focus on lossless in-order packet delivery to overcome a residual MAC PDU loss, but at the cost of processing for recovery and subsequent round-trip delays added for recoveries. Hence, simplifying the procedure is necessary to achieve next-generation application performance without complicating the existing procedures. Simplification, optimization, and convergence are a necessity for ensuring a very lean and agile protocol stack for modem processing, where the current state of the art is adding overheads that can be avoided.

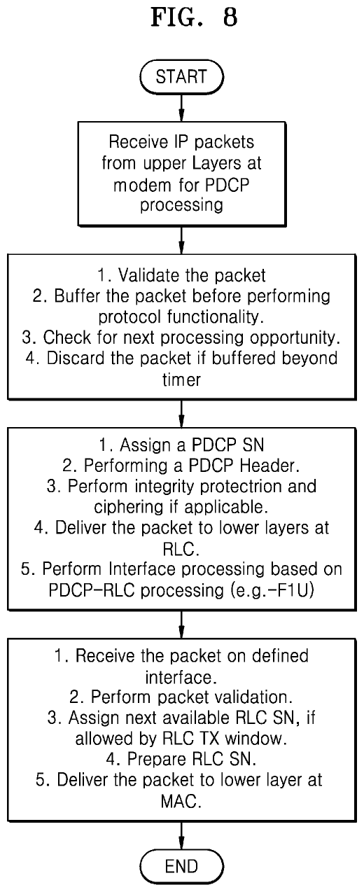

FIG. 8 depicts the procedures that take place in an existing protocol stack according to the related art. Certain IP packets are received from the upper layers at the modem for PDCP processing. Further, IP packets are validated and buffered before performing protocol functionality. Further, IP packets are checked for the next processing opportunity and discarded, if buffered beyond the discard timer. The existing protocol stack assigns a PDCP SN and PDCP Headers, performs integrity protection and ciphering (if applicable), and delivers the packet to lower layers at the RLC. Further, the existing protocol stack receives the packet on a defined interface after performing interface processing based on PDCP-RLC processing; for example, F1U and packet validation. Further, the existing protocol stack assigns the next available RLC SN (if allowed by the RLC TX window), prepares the RLC SN, and delivers the packet to the lower layer at the MAC.

To achieve the aforementioned requirements, a communication protocol for the modem should provide at least, for example, a highly efficient way of packing information, minimal overhead in terms of processing, light functionalities, scalable solutions, and a reliable mechanism for service to upper layers.

Thus, it is desirable to have a solution to define a simplified protocol with a lean and agile user plane protocol stack to meet the strict processing requirements to meet throughput and latency KPIs and provide reliable and jitter-free communication.

Hence, there is a need in the art for solutions which will overcome the above mentioned drawback(s), among others.

FIG. 9 depicts a single L2 layer for fast transfer of data with a single windowing mechanism, a single protocol header, clear segregation between real-time and non-real time processing, and all other functionalities (such as, but not limited to, recovery mechanisms, retransmissions, duplicate detection, security, header compression, and decompression) according to an embodiment of the disclosure. The proposed embodiments herein disclose details and variants of the header structure required for fast-path processing for a protocol stack having a Converged Layer2 functionality.

The proposed protocol stack has simplified the protocol for a high-speed packet processing network by merging the functionalities of all the Layer 2 (L2) modules (especially PDCP and RLC) into a single network function, which provides an opportunity to make the processing lighter. Making the data plane L2 layer processing completely soft real-time in nature helps in deployment into the cloud as well as make real-time processing requirements much lighter in nature and meet the requirements of the physical layer or Layer 1 processing.

The embodiments herein explain the operations to be performed once the IP packets have been received by the single L2 layer. The L2 layer can cluster packets into a single Protocol Data Unit (PDU), assigning a single Sequence Number (SN), updating a transmitter (TX) window, and then forwarding the packet to the MAC layer for further processing. The L2 layer can also operate for error recovery and retransmission based on the status PDU structure as per the state of the art. Further, the L2 layer is also responsible for performing data security by performing ciphering and integrity protection on the received IP packets (termed as Service Data Units (SDUs)). It can optionally perform header compression or decompression on these SDUs. Similarly, on the receiver side, the L2 layer is responsible for header parsing, SN extraction, updating receiver window variables, performing the reordering mechanism as per prior art, preparing status PDUs as per prior art, and maintaining timers similar to RLC as per prior art. The receiver can also perform decompression of the encrypted data if the security feature has been configured.

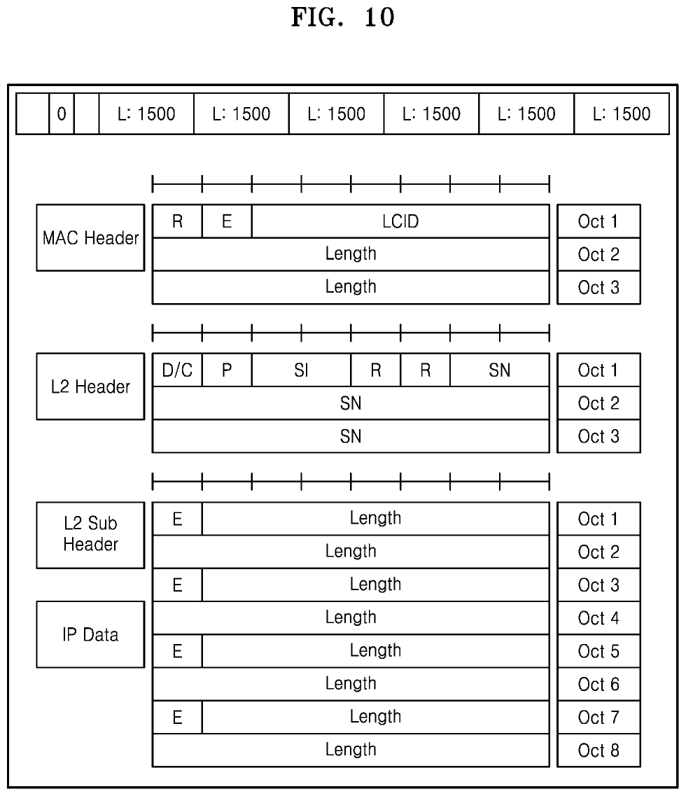

FIG. 10 depicts a smart header structure to reduce the processing overhead of a modem protocol according to an embodiment of the disclosure. In modem protocol processing, the processing cycles involved are directly proportional to the number of headers present in the packet, as the transmitter's job is to create as many headers as required and the receiver's job is to manage the received headers and send the packets in order. In most of the protocol functionalities, the payload does not matter. The protocol's memory requirement for its metadata is also directly proportional to the number of sequence numbers managed by that protocol layer. Actual data packet size does not matter during processing, as various data packets can still be managed and merged using Hardware (HW) Direct Memory Accelerators (DMA), which can copy data from one memory location to another. This process can be enhanced by having an enhanced DMA. It is possible that multiple packets placed at multiple different non-contagious memory locations can still be converted into a single contiguous payload by using these DMA HWs, which do not need very high processing in Software (SW). It is also possible that at the receiver side, the header can be separated from the bigger payload and processed as the payload is not accessed often if the header structure contains all the information of the packet in a single header. Concatenation provides a better opportunity to reduce the number of headers and has been widely addressed through various schemes for concatenation as per existing prior art.

The embodiments herein explain multiple header structure options for fast-path processing. According to one of the embodiments, a Converged Layer2 (L2) header is assigned a single sequence number to manage multiple data packets. An L2 Sub-Header is assigned while the IP packets are clustered in the single PDU. The L2 Sub-Header comprises two important fields:
E bit (or Extension Bit): A single bit indication of whether it is followed by another L2 Sub-Header,
0—no L2 Sub-Header further exists,
1—Another L2 Sub-Header exists.
Length field: a 15-bit field indicating the length of the IP packet. (Limitation: IP packet size is not more than 32767 bytes.)

A single L2 Header with SN is assigned with a header similar to NR RLC.

There is only one SN present in the entire PDU. In this particular variant of the header structure, all the packet header information can be together and can be in the contiguous memory region within the MAC PDU. All the L1 field information can be packed together.

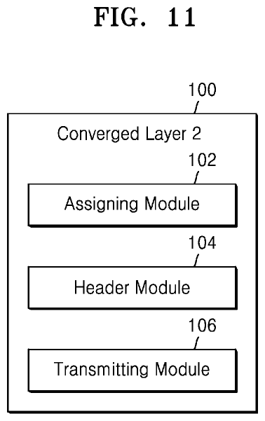

FIG. 11 depicts the Converged Layer2 100 (single L2 layer) for processing at least one Internet Protocol (IP) packet according to an embodiment of the disclosure. The Converged Layer2 is designed by converging functionalities from a Radio Link Control (RLC) protocol and a Packet Data Convergence Protocol (PDCP) in a Converged Layer2 protocol. The Converged Layer2 100 comprises an assigning module 102, a header module 104, and a transmitting module 106. The assigning module 102 can receive at least one IP packet as a Service Data Unit (SDU) from an IP layer. The assigning module 102 can validate the received at least one IP packet. The assigning module 102 can buffer the validated at least one IP packet and discard the buffered at least one IP packet if buffered beyond a discard timer. The assigning module 102 can assign a sequence number to at least one IP packet received. Assigning the sequence number to the received at least one IP packet comprises performing SDU chaining (if concatenation has been configured). The header module 104 can add at least one L2 Header to the received IP packet to process the PDU. The header module 104 can detect a plurality of IP packets present in a cluster and assign a L2 Sub-Header to the plurality of IP packets upon detecting that more than one IP packet is present in the cluster. The L2 Sub-Header comprises an Extension (E) field, a length field, which indicates the length of the IP packet, and an indication that a plurality of IP packets (SDUs) are present in the cluster, which indicates the presence of the next L2 Sub-Header and the IP packet. The transmitting module 106 can update the transmitter (TX) window of the added at least one L2 Header to the received at least one PDU. The transmitting module 106 can perform integrity protection and ciphering on the updated PDU. The transmitting module 106 can transmit the processed at least one PDU to at least one MAC lower layer.

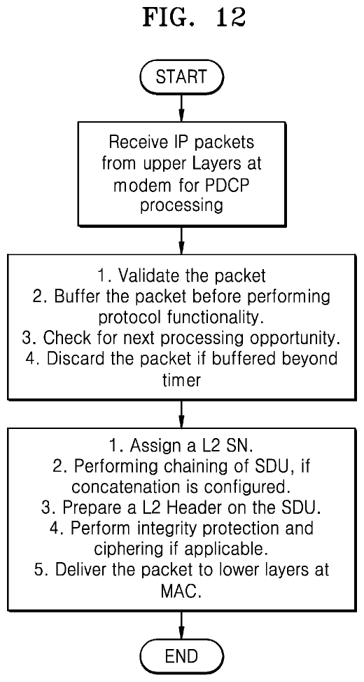

FIG. 12 illustrates the operations to be performed once the IP packets have been received by the single L2 layer according to an embodiment of the disclosure. The single L2 layer validates and buffers the IP packets before performing protocol functionality. Further, IP packets are checked for the next processing opportunity and discarded (if buffered for a long period or beyond the discard timer). The single L2 layer assigns a L2 SN to at least one IP packet received as Service Data Unit (SDU) from an IP layer and performs SDU chaining (as per the concatenation configured). When concatenation is configured, there are multiple steps involved related to the concatenation process. For example, how many data packets combine or cluster together for a specified period? Further, the single L2 layer prepares the L2 Header on the SDU to process a PDU. Further, the single L2 layer performs some operations related to data security, including but not limited to integrity protection and ciphering. Further, the single L2 layer delivers at least one processed PDU to the lower layers at MAC.

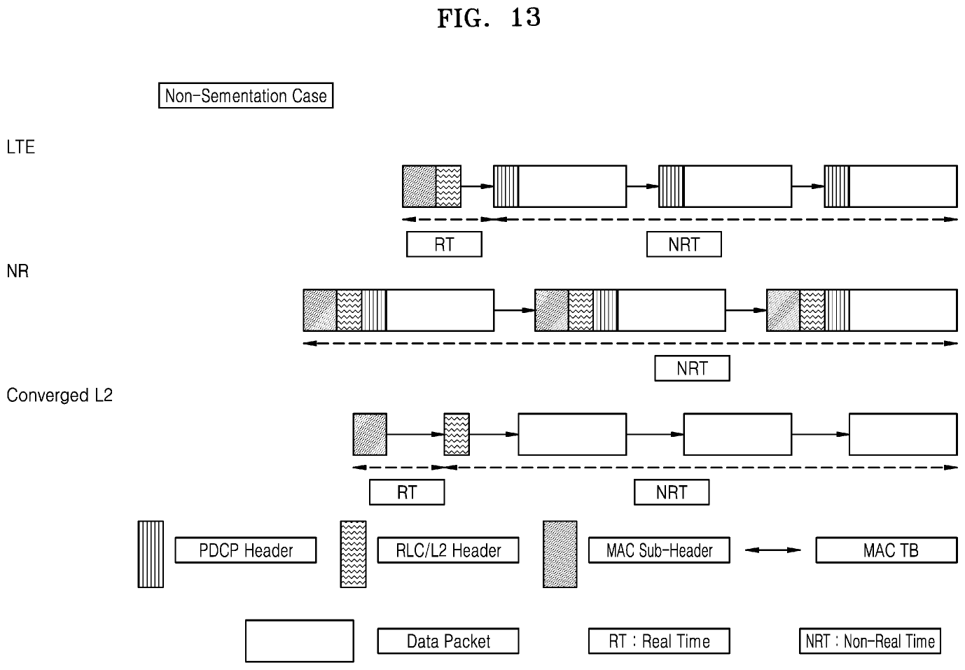

FIG. 13 illustrates the difference in handling between LTE, NR, and Converged Layer2 100 according to an embodiment of the disclosure. In the fourth-generation wireless system, data packets are chained with the assigned PDCP Headers, on receiving the grants from a lower layer and assigned one RLC SN and Mac Sub-Header. Whereas in the fifth-generation wireless system, every data packet has a PDCP SN, RLC SN, and MAC Sub-Header. It is considered a non-segmentation case, and all those packets have to be packed after receiving the grants from a lower layer. As a result, the number of headers present in the 5G has increased. Embodiments as disclosed herein assign the L2 Header in non-real time for an N number of data packets, such that the form is called the cluster. In the case of no segmentation, which means that the grants received from the lower layer are sufficient to transmit the already prepared packets and assign the MAC Sub-Header in real-time. All the data packets will be assigned a single sequence number based on a pre-defined configuration. In an embodiment herein, the length information can be present in the L2 Header. In an embodiment herein, the length information can be present along with the data packets to get different variants in a pre-defined period of time. As a result, the number of headers required will be drastically dropped by 1/N due to assigning one single identifier to N data packets and the procedural requirements will be simplified by introducing just one single identifier (as one single identifier is responsible for the complete chain of packets). Therefore, there is no need for individual processing that what packets belong to which sequence number, which was the issue with the earlier case in 4G and 5G. In 4G, every data packet has a PDCP sequence number identifier, and in 5G, every data packet has a PDCP and RLC sequence number identifier, whereas in the proposed embodiment only one single identifier is responsible for the complete chain of packets results in the simplified way of processing.

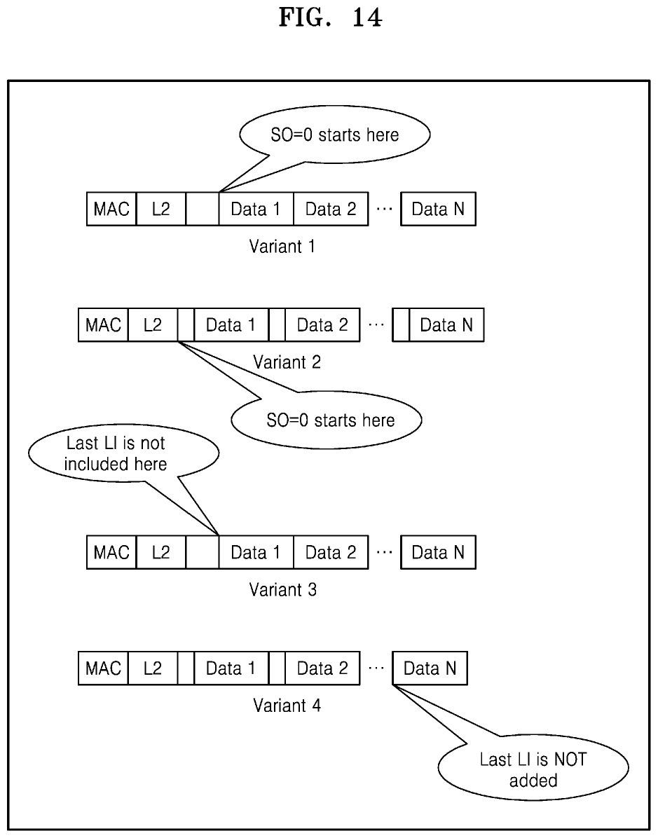

FIG. 14 illustrates a scenario, where there is concatenation at the L2 layer according to an embodiment of the disclosure. In the embodiment shown herein, it is further possible that the last Length Indicator Sub-Header is not included while packing the structure as shown in variant 3. In this case, the length field present in the MAC Sub-Header can be used to calculate the length of the last SDU packed in the field. Thus, in case only one packet is to be sent in MAC PDU, the Length Indicator field will not be present. In such a case, the L2 Header will need a Length Indicator Extension (LIE) field to indicate whether the L1 field exists or not or through a special field in the MAC Sub-Header as well.

In an embodiment herein, the header structure for the Converged Layer2 100 shows the single SN being assigned to multiple data packets received from an upper layer. Optional header structures and variants can consider various fields to represent the multiple packets packed in the header structure. Every packet can be a fixed or variable size. Moreover, multiple variants are possible. Although the L2 Header can remain in fixed size as having similar information, which exists in RLC, the L2 Sub-Header which consists of the length information can be of different types. The L2 Sub-Header can be located for all the packets within the particular PDU at a single place as shown in FIG. 10, such that all the header information exists in the L2 Sub-Header only, or else there is an option that every packet can have its length indicator information placed at the boundary of the particular packets to indicate the beginning of the packet.

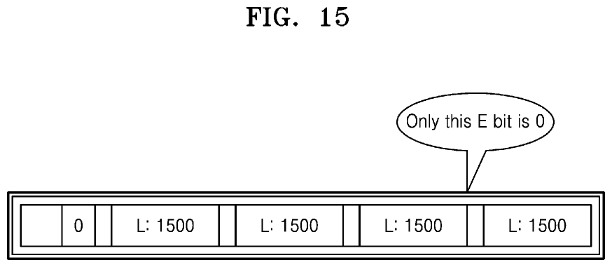

FIG. 15 illustrates another example of the proposed packet structure based on the length indicator fields placed along with the data packets, or SDUs according to an embodiment of the disclosure. In the embodiment shown herein, the L2 Sub-Header location need not need be placed together at the front of the MAC PDU along with the L2 Header. The Length Indicator L2 Sub-Header may be placed along with the data packet at the front of each data packet. In this case, the last SDU's corresponding L2 Sub-Header will contain the E bit or the Extension bit to be set to 0 to indicate that no further SDU post this SDU is present in the MAC PDU, as shown in FIG. 14 variant 2 and variant 4.

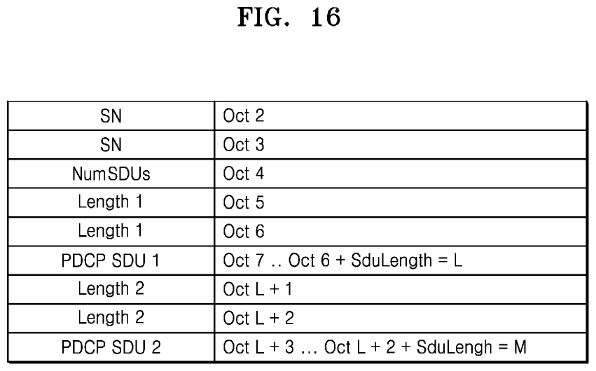

FIG. 16 illustrates another variant of the proposed header structure containing extra fields for a number of SDUs according to an embodiment of the disclosure. The E bit can also be replaced by what can be defined as NumSDUs, or the number of SDUs in the payload. In this case, the number of SDUs is an 8-bit field to indicate the total number of SDUs present. In this variant, it is possible to keep the length field at 16 bits. This allows the length of the individual IP packets to be as large as 65575 bytes. Further, no bit processing or masking is required to read the length of the individual IP packets. In this variant, it is also possible that all the length indicators can be kept together as well.

Tables 1-3 shows state variables: PDCP/RLC vs. Converged Layer2 100. This may or may not be restricted to the headers mentioned in the proposed embodiment. The single windowing mechanism requires appropriate window state variables and timers to handle the flow. Traditionally, according to existing arts, different modes like Acknowledged Mode (AM) and Unacknowledged Mode (UM) will need to be supported. Most of the state variables have a direct reference to NR RLC state variables, except for a few state variables that won't be required due to the single L2 operation. For UM Mode, the state variables are required to be stored about the TX_NEXT as such only to maintain the next SN to be transmitted. Since there is no acknowledgment to be received in this case, the transmitting window just keeps assigning sequence numbers to the packets to ensure in-order delivery from the receiver end. The receiver needs to maintain RX_NEXT, which indicates the lowest SN yet to be received, RX_NEXT_TRIGGER, which indicates the SN that caused the out-of-order process for reordering the packets, and RX_NEXT_HIGHEST, which indicates the next SN to the highest SN yet received. Similarly, apart from this, the AM state variables also require TX_NEXT_ACK to maintain the lower edge of the transmitting window, indicating the smallest SN yet to be acknowledged. Also, the received side will have RX_NEXT_HIGHEST_STATUS for reporting the status report to the transmitter entity. Apart from this, most of the timers, like timers for polling, timers for reordering, and timers for status prohibit. Also, a timer for discarding timer-like functionality needs to be maintained in the single layer. Additionally, a COUNT variable can be kept at Converged Layer2, if required. Under special operating scenarios like handling side-link communication, relays, or multiple hop-based Integrated Access and Backhaul (IAB) deployments, additional state variables can be required. For example, in case of IAB deployments, the mapping information has to be stored and conveyed for the backhaul mapping and the forwarding packet, the mapping can be maintained via additional fields and variables. For handling security for the RAN packets, additional COUNT for SDUs state variables can be required.

TABLE 1

| PDCP | Remarks |
|---|---|
| TX_NEXT | Required to keep track of lower edge transmitter side |
| | window |
| RX_NEXT | Required to keep track of higher received packets of |
| | received entity window |
| RX_DELIV | Required to mark lower edge of the receiver entity |
| | window |
| RX_REORD | Marks the SN which triggered the t-reordering |
| COUNT | Absolute COUNT value of the packet used for ciphering |
| | and integrity protection |

Note:
1. Tx_Next and Rx_Next are common to both RLC and PDCP.
2. PDCP state variables other than count are for ensuring in-sequence delivery.
3. The count variable is for ciphering and integrity protection.
4. RLC AM operates in a push window, whereas NR PDCP works only in the push window.
Only RLC UM operates in a pull window.
5. LTE PDCP had the push and pull window for AM and UM.

TABLE 2

| RLC | Remarks |
|---|---|
| TX_NEXT | Required to keep track of lower edge |
| | transmitting window |
| TX_NEXT_ACK | State variable to maintain the packet is yet to |
| | be acknowledged |
| POLL_SN | Stores SN for which Poll was sent |
| PDU_WITHOUT_POLL | Total PDUs sent without poll |
| BYTE_WITHOUT_POLL | Total byte sent without poll |
| RETX_COUNT | Number of times retx was performed for a |
| | RLC SDU |
| RX_Next | Required to keep track of lower edge of |
| | receiving window |
| RX_Next_Status_Trigger | Points to the SN next to the SN which |
| | triggered t-reassembly. Used in AM |
| RX_Highest_Status | AM state variable to maintain the highest SN |
| | for which an ACK can be sent in status |
| | report |
| RX_Next_Highest | State variable to maintain the highest SN |
| | received +1 |
| RX_Next_Reassembly | UM state variable containing value of |
| | earliest SN that is still considered |
| | for reassembly |
| RX_Timer_Trigger | UM state variable containing the SN |
| | following the SN which triggered |
| | t-reassembly |

TABLE 3

| Entity | Converged Layer2 | Remarks |
|---|---|---|
| TX/RX | Count | As per PDCP, (Used only for |
| | | security key inputs as such) |
| TX | TX_Next | As per RLC |
| | TX_Next_Ack | As per RLC (Used only for AM) |
| | POLL_SN | As per RLC (Used only for AM) |
| | PDU_WITHOUT_POLL | As per RLC (Used only for AM) |
| | BYTE_WITHOUT_POLL | As per RLC (Used only for AM) |
| | RETX_COUNT | As per RLC (Used only for AM) |
| RX | RX_Next | As per RLC |
| | RX_Next_Trigger | RX_Next (Variables name is |
| | | same for AM/UM, functionality is |
| | | different as per NR RLC) |
| | RX_Highest_Status | As per RLC (Used only for AM) |
| | RX_Next_Highest | As per RLC |

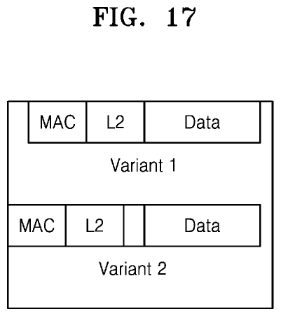

FIG. 17 illustrates a scenario where there is only a single data packet or no concatenation at Layer 2 according to an embodiment of the disclosure. It is further possible that there may or may not be concatenation support or value configured at Layer 2 as another variant of this embodiment. In this case, there is only one packet in the PDU, which is assigned the single L2 SN. It is also possible that there may be length indicator field added to the L2 packet itself.

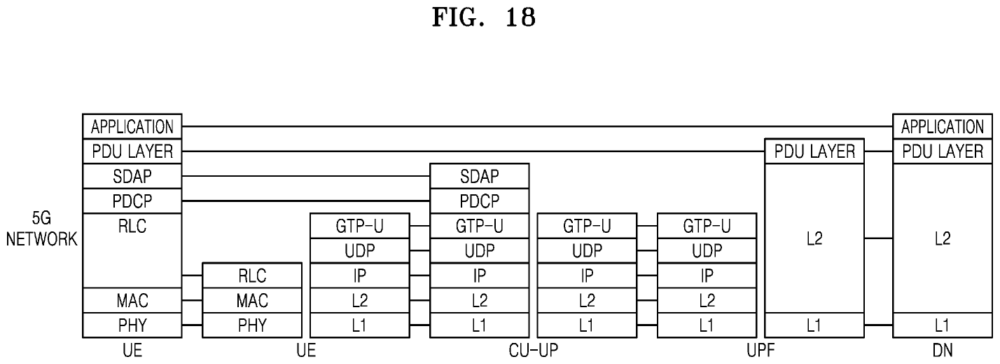

FIG. 18 shows the end-to-end protocol stack view as per the existing state-of-the-art Radio Access Network (RAN) deployment according to an embodiment of the disclosure. The end-to-end protocol stack view of the complete layer processing across all the modules of interest in data plane processing right from Application to User Plane Function (UPF) in the Core Network, followed by Centralized Unit (CU) and Distributed Unit (DU) at RAN and then the UE, as per the prior art for NR protocol.

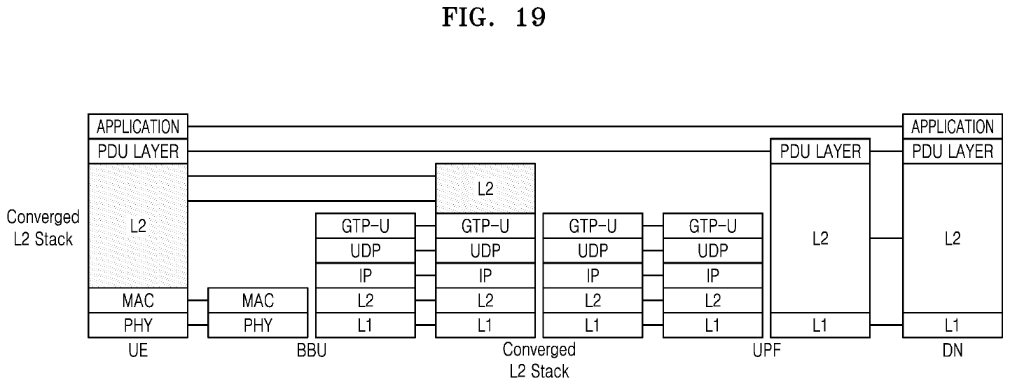

FIG. 19 shows one variant based on the proposed architecture impact due to Converged Layer2 according to an embodiment of the disclosure. In the embodiment shown here, when the Converged Layer2 is introduced, it is possible to split the processing and perform all Converged Layer2 operations in non-real time at a centralized unit and have only MAC and lower functionalities at the DU or Base Band Unit (BBU).

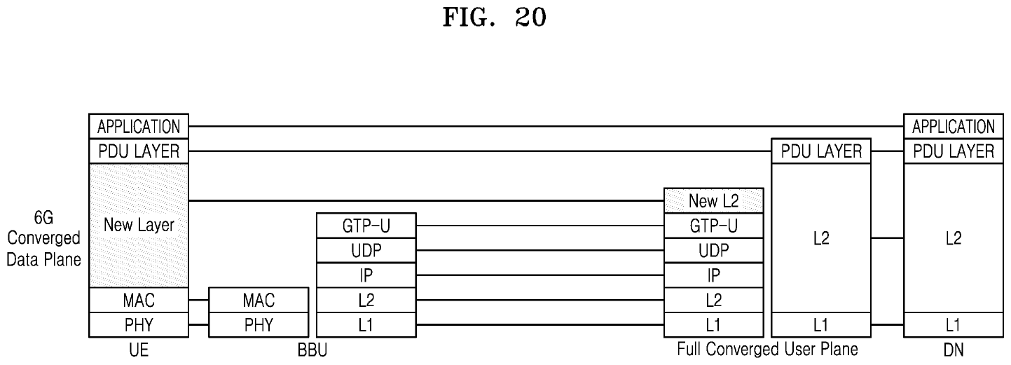

FIG. 20 shows another variant based on the proposed architecture for the single layer 2 and converged UPF according to an embodiment of the disclosure. FIG. 20 shows further merging of UPF and Converged Layer2 to form the single layer of operation for the user plane processing. It is possible that due to the differences in placement of these modules, there will be an impact on the interfaces defined between them.

Thus, with the aforementioned multiple variants of header structure and the proposed locations at which the processing can be processed, the proposed embodiment tries to simplify much of the processing.

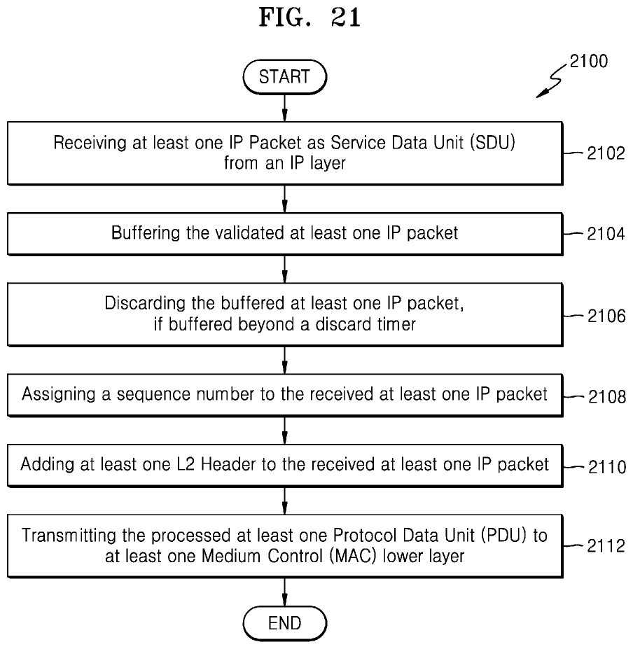

FIG. 21 is a flowchart illustrating a method 2100 for processing at least one Internet Protocol (IP) packet according to an embodiment of the disclosure. The operations (2102-2112) are handled by the Converged Layer2 100. At operation 2102, the method discloses receiving, by a Converged Layer2, at least one IP packet as Service Data Unit (SDU) from an IP layer. The Converged Layer2 is designed by converging functionalities from a Radio Link Control (RLC) protocol and a Packet Data Convergence Protocol (PDCP) into a Converged Layer2 protocol.

At operation 2104, the method discloses validating, by the Converged Layer2, the received at least one IP packet. The method further discloses buffering, by the Converged Layer2, the validated at least one IP packet.

At operation 2106, the method discloses checking, by the Converged Layer2, for the next processing opportunity. The method further discloses discarding, by the Converged Layer2, the buffered at least one IP packet, if buffered beyond a discard timer.

At operation 2108, the method discloses assigning, by the Converged Layer2, a sequence number to the received at least one IP packet. The L2 Header is assigned with the single sequence number to the entire Converged Layer2 (PDU) to manage at least one IP packet present in the cluster. The method of assigning the sequence number to the received at least one IP packet comprises performing SDU chaining if concatenation is configured.

At operation 2110, the method discloses adding, by the Converged Layer2, at least one L2 Header to the received at least one IP packet. The method further discloses assigning, by the Converged Layer2, the L2 Sub-Header to the plurality of IP packets, on detecting that more than one IP packet is present in the cluster. The L2 Sub-Header consists of two fields including the Extension (E) field and length field indicating the length of the IP packet and includes an indication that the plurality of IP packets (SDUs) present in the cluster indicating the presence of the next L2 Sub-Header.

At operation 2112, the method discloses updating, by the Converged Layer2, a transmitter (TX) window of the added at least one L2 Header to the received at least one IP packet. The method further discloses performing, by the Converged Layer2, integrity protection and ciphering on the updated at least one IP packet and forwarding (transmitting), by the Converged Layer2, the processed at least one IP packet (PDU) to at least one lower layer at MAC.

The various actions, acts, blocks, steps, or the like in the method and the flow diagram 2100 may be performed in the order presented, in a different order, or simultaneously. Further, in some embodiments, some of the actions, acts, blocks, steps, or the like may be omitted, added, modified, skipped, or the like without departing from the scope of the disclosure.

The embodiment shown herein defines a data link layer design. The data link layer is a combination of Layer2 in the protocol stack and assigns a single sequence number for a packet handled at Layer 2, which implies handling the packet above the MAC using a single windowing mechanism because of assigning the single sequence number to the multiple packets. Moreover, concatenation is an important operation that is to be performed and assigns the single SN to the entire single payload, which contains multiple packets. Therefore, all the mechanisms are handled by a single sequence number in the proposed protocol stack.

Table 4 shows the benefits and requirements of concatenation in a summarized way and addresses some of the generalized issues related to concatenation, such as what the need for concatenation is and how many sequence numbers can be managed for processing multiple packets. The benefits of concatenation result in a fixed-size protocol Header, concatenation at or above PDCP, reduced PDCP SN and RLC SN ranges, and efficient packing information. With the increase in the required throughput, the number of packets to be processed per second scales up (pps=packets per second, Mpps=million packets per second). Further, if the packet size reduces, the throughput requirement is much more stringent, with the number of IP packets required to be processed scaling further up. With the higher number of packets at each layer, the header packaging complexity increases in the transmitter entity. At the same time, receiver complexity increases due to the number of header parsing steps required. For a large number of SN ranges, the reordering and window complexity also increases exponentially at the receiver entity.

TABLE 4

| | | |
|---|---|---|
| Throughput | Mpps (1500 B) | Mpps (64 B) |

| | | | |
|---|---|---|---|
| 5 | Gbps | 0.42 | 9.77 |
| 20 | Gbps | 1.67 | 39.06 |
| 100 | Gbps | 8.33 | 195.31 |

Table 5 shows the comparison with the prior art, their pros and cons, and the shortcomings of all existing methods. All approaches, such as concatenation at PDCP or RLC, show that the PDCP and RLC windows still exist. However, this is not the case in the proposed embodiment. The major advantage of the proposed embodiment is single layer operation. The nomenclature of these headers, such as PDCP Headers, PDCP Sub-Headers, RLC Headers, RLC Sub-Headers, and MAC Sub-Headers might change. The Headers contain sequence number information, and the Sub-Headers contain anything that belongs to that particular sequence number with all additional information required for each packet. The proposed embodiment needs the L2 Sub-Header and PDCP concatenation header is required per packet, as measured by N. However, the proposed embodiment considers the L2 Header only in the absence of the PDCP Header. Therefore, the total number of Headers required becomes N+2.

TABLE 5

| | | | | Concatenation | Concatenation | Converged |
|---|---|---|---|---|---|---|
| Feature | | LTE | NR | at RLC | at PDCP | Layer2 |
| Number | PDCP | 0 | 0 | 0 | N | N |
| of | Sub- | | | | | |
| | Header | | | | | |
| | PDCP | N | N | N | 1 | 0 |
| | Header | | | | | |
| | RLC | N | 0 | N | 0 | 0 |
| | Sub- | | | | | |
| | Header | | | | | |
| | RLC | 1 | N | 1 | 1 | 1 |
| | Header | | | | | |
| | MAC | 1 | N | 1 | 1 | 1 |
| | Sub- | | | | | |
| | Header | | | | | |

| | | | | | |
|---|---|---|---|---|---|
| Total Headers | 2N + 2 | 3N | 2N + 2 | N + 3 | N + 2 |
| Advantage | Low SN | Pre- | Pre- | Reduced | Single |
| | range | Processing | processing | processing | Layer |
| | | Efficient | | at PDCP, RLC | operation |
| | | Segment Info | | | |
| Disadvantages | No Pre- | Large | Simplification | Concatenation | |
| | processing | Number of SN | only at RLC, | before receiving | |
| | | | No gain in | the grants can lead | |
| | | | PDCP processing | to segmentations | |

The embodiments disclosed herein can be implemented through at least one software program running on at least one hardware device and performing network management functions to control the elements. The elements can be at least one of a hardware device, or a combination of hardware device and software module.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a converged layer 2 (L2) for processing at least one internet protocol (IP) packet in a wireless communication system, the method comprising:
receiving, by the converged L2, at least one IP packet as a service data unit (SDU) from an IP layer;
assigning, by the converged L2, a sequence number to the received at least one IP packet;
adding, by the converged L2, at least one L2 header to the received at least one IP packet to process a protocol data unit (PDU); and
transmitting, by the converged L2, the processed at least one PDU to at least one medium access control (MAC) lower layer.

2. The method of claim 1, wherein the converged L2 is designed by converging functionalities from a radio link control (RLC) protocol and a packet data convergence protocol (PDCP) in a converged L2 protocol.

3. The method of claim 1, further comprising:
validating the received at least one IP packet;
buffering the validated at least one IP packet; and
discarding the buffered at least one IP packet, if buffered beyond a discard timer.

4. The method of claim 1, wherein the assigning of the sequence number to the received at least one IP packet comprises performing SDU chaining, if concatenation is configured.

5. The method of claim 1, further comprising:
detecting a plurality of IP packets present in a cluster; and
assigning a L2 sub-header to the plurality of IP packets, on detecting that more than one IP packet are present in the cluster.

6. The method of claim 5, wherein the L2 sub-header comprises:
an extension (E) field;
a length field, wherein the length field indicates a length of a corresponding IP packet; and
an indication of whether a plurality of IP packets are present in the cluster, wherein the indication that the plurality of IP packets are present in the cluster indicates a presence of a next L2 sub-header and the corresponding IP packet.

7. The method of claim 1, wherein the transmitting of the processed at least one PDU to at least one MAC lower layer comprises:
updating a transmitter (TX) window of the added at least one L2 header to the received at least one IP packet;
performing integrity protection and ciphering on the at least one IP packet having the updated TX window; and
forwarding the processed at least one PDU to at least one MAC lower layer.

8. An electronic device having a converged layer 2 (L2) for processing at least one internet protocol (IP) packet, the electronic device comprising:
memory; and
one or more processors communicatively coupled to the memory,
wherein the memory store one or more computer programs including computer-executable instructions that, when executed by the one or more processors, cause the electronic device to:
receive at least one IP packet as a service data unit (SDU) from an IP layer,
assign a sequence number to the received at least one IP packet;
add at least one L2 header to the received at least one IP packet to process a protocol data unit (PDU); and
transmit the processed at least one PDU to at least one medium access control (MAC) lower layer.

9. The converged L2 of claim 8, wherein the converged L2 is designed by converged functionalities from a radio link control (RLC) protocol and a packet data convergence protocol (PDCP) protocol in a converged L2 protocol.

10. The converged L2 of claim 8, wherein the one or more computer programs further comprise computer-executable instructions that, when executed by the one or more processors, cause the electronic device to:
validate the received at least one IP packet;
buffer the validated at least one IP packet; and
discard the buffered at least one IP packet, if buffered beyond a discard timer.

11. The converged L2 of claim 8, wherein the one or more computer programs further comprise computer-executable instructions that, when executed by the one or more processors, cause the electronic device to assign the sequence number to the received at least one IP packet comprises performing SDU chaining, if concatenation is configured.

12. The converged L2 of claim 8, wherein the one or more computer programs further comprise computer-executable instructions that, when executed by the one or more processors, cause the electronic device to:
detect a plurality of IP packets present in a cluster; and
assign a L2 sub-header to the plurality of IP packets, on detecting that more than one IP packet are present in the cluster.

13. The converged L2 of claim 12, wherein the L2 sub-header comprises:
extension (E) field;
a length field, wherein the length field indicates a length of a corresponding IP packet; and
an indication of whether a plurality of IP packets are present in the cluster, wherein the indication that the plurality of IP packets are present in the cluster indicates a presence of a next L2 sub-header and the corresponding IP packet.

14. The converged L2 of claim 8, wherein the one or more computer programs further comprise computer-executable instructions that, when executed by the one or more processors, cause the electronic device to:
update a transmitter (TX) window of the added at least one L2 header to the received at least one IP packet;
perform integrity protection and ciphering on the at least one IP packet having the updated TX window; and
forward the processed at least one PDU to at least one MAC lower layer.

15. One or more non-transitory computer-readable storage media storing one or more computer programs including computer-executable instructions that, when executed by one or more processors of an electronic device, cause the electronic device to perform operations, the operations comprising:
receiving, by a converged layer 2 (L2), at least one internet protocol (IP) packet as a service data unit (SDU) from an IP layer;
assigning, by the converged L2, a sequence number to the received at least one IP packet;
adding, by the converged L2, at least one L2 header to the received at least one IP packet to process a protocol data unit (PDU); and
transmitting, by the converged L2, the processed at least one PDU to at least one medium access control (MAC) lower layer.

16. The one or more non-transitory computer-readable storage media of claim 15, wherein the converged L2 is designed by converging functionalities from a radio link control (RLC) protocol and a packet data convergence protocol (PDCP) in a converged L2 protocol.

17. The one or more non-transitory computer-readable storage media of claim 15, the operations further comprising:
validating the received at least one IP packet;
buffering the validated at least one IP packet; and
discarding the buffered at least one IP packet, if buffered beyond a discard timer.

18. The one or more non-transitory computer-readable storage media of claim 15, wherein the assigning of the sequence number to the received at least one IP packet comprises performing SDU chaining, if concatenation is configured.

19. The one or more non-transitory computer-readable storage media of claim 15, the operations further comprising:
detecting a plurality of IP packets present in a cluster; and
assigning a L2 sub-header to the plurality of IP packets, on detecting that more than one IP packet are present in the cluster.

20. The one or more non-transitory computer-readable storage media of claim 19, wherein the L2 sub-header comprises:
an extension (E) field;
a length field, wherein the length field indicates a length of a corresponding IP packet; and
an indication of whether a plurality of IP packets are present in the cluster, wherein the indication that the plurality of IP packets are present in the cluster indicates a presence of a next L2 sub-header and the corresponding IP packet.
